(19) United States
(12) Patent Application Publication
(10) Pub. No.: US 2018/0170237 A1
(43) Pub. Date: Jun. 21, 2018

(54) DEVICE FOR SECURING LOADED MATERIAL IN A LOADING SPACE OF A MOTOR VEHICLE

(71) Applicant: BOS GMBH & CO. KG, Ostfildern (DE)

(72) Inventors: Wolfram ZUMMACK, Troisdorf (DE); Bogdan TUTELEA, Leichlingen (DE); Wolfgang SITZLER, Wuppertal (DE); Tanja PINK, Wuppertal (DE); Andreas GÖBBELS, Kürten (DE); Hartmut BOHLKE, Wuppertal (DE); Jan BODDENBERG, Köln (DE)

(21) Appl. No.: 15/737,127

(22) PCT Filed: Apr. 11, 2016
(86) PCT No.: PCT/EP2016/057939

§ 371 Date: Dec. 15, 2017

(30) Foreign Application Priority Data
Jun. 18, 2015 (DE) 102015211295.0

(51) Int. Cl. B60P 7/08; B60P 7/15

(52) U.S. Cl. CPC B60P 7/0815; B60P 7/15; B60P 7/0807

(57) ABSTRACT

Device for securing loaded material in a loading space of a motor vehicle with at least one load rail which can be anchored fixedly to the vehicle on a loading space floor and is configured as a hollow profile with a longitudinal groove which is open toward the loading space, and with at least one load-receiving module which has a carrier body, which is displaceable and lockable in the load rail, and a load eye which is mounted movably on the carrier body between an inoperative position lowered into the load rail and a functional position protruding upward over the load rail. The carrier body has an oblique supporting plane, along which the load eye is guided in a shiftable manner between the inoperative position and the functional position, and in which the load eye is deposited in the inoperative position.

The invention relates to a device for securing loaded material in a loading space of a motor vehicle, with at least one load rail which can be anchored fixedly to the vehicle and is configured as a hollow profile, which is provided with a longitudinal groove which is open toward the loading space and is flanked by at least one latching track arrangement, which is provided with at least one row of latching recesses arranged one behind another in the longitudinal direction of the load rail, and with at least one load-receiving module which is arranged in the load rail in a displaceable and lockable manner, wherein the load-receiving module has at least one latching cam which, in a latching position of the load-receiving module, engages in a latching recess of the latching track arrangement.

The invention also relates to a device for securing loaded material in a loading space of a motor vehicle, with at least one load rail which can be anchored fixedly to the vehicle on a loading space floor and is configured as a hollow profile with a longitudinal groove which is open toward the loading space, and with at least one load-receiving module which has a carrier body, which is displaceable and lockable in the load rail, and a load eye which is mounted movably on the carrier body between an inoperative position lowered into the load rail and a functional position protruding upward over the load rail.

DE 10 2011 087 363 A1 discloses a device for securing loaded material in a loading space of a motor vehicle. The known device has a load rail which can be anchored fixed to the vehicle, is configured as a hollow profile and has an upwardly open longitudinal groove. Integrated in the load rail is a latching track arrangement in the form of a latching strip arrangement which is provided with a row of latching recesses which are arranged at uniform distances from one another and are open toward the longitudinal groove of the load rail. A side of the longitudinal groove that is opposite the latching strip arrangement is formed by an arched supporting contour which is formed integrally in the hollow profile of the load rail and extends over an entire length of the hollow profile. A load-receiving module can be inserted through the longitudinal groove into the load rail, said load-receiving module being provided with a hook-shaped insertion extension, which is curved in a complementary manner with respect to the supporting contour of the load rail, and with a blocking part which can be blocked in the latching recesses of the latching strip arrangement as soon as the load-receiving module is inserted into the load rail. The load-receiving module, in its operating position inserted into the load rail, is placed substantially on top of a surface of the load rail. Only the insertion extension and the locking part project into the hollow profile of the load rail.

It is an object of the invention to provide a device of the type mentioned at the beginning which permits lowering of the load-receiving module flush with the load rail and also ensures crashproof securing of the load-receiving module in the load rail.

This object is achieved in that two latching track arrangements are arranged on opposite sides of the longitudinal groove, and in that the latching recesses thereof are each closed toward the longitudinal groove. By means of a load-receiving module within the meaning of the invention, objects which are to be transported can be fixed in the loading space of the motor vehicle. In the event of a vehicle impact (a crash), extreme forces can act on the load-receiving module, said forces leading, in the case of the prior art, to the load rail being expanded in the region of the position of the load-receiving module and the load-receiving module being torn out of the load rail. By means of the solution according to the invention, the profile limbs of the hollow profile, said profile limbs flanking the longitudinal groove of the load rail, are clamped in a form-fitting manner against one another via the latching cams of the load-receiving module such that no expansion of the load rail in the region of the longitudinal groove and no release of the load-receiving module in the case of a vehicle impact can occur. According to the invention, transversely with respect to the longitudinal direction of the longitudinal groove a form fit is produced between the load rail sides flanking the longitudinal groove via the load-receiving module which engages by means of its latching cams in a corresponding form-fitting manner in the opposite latching track arrangements.

The object on which the invention is based is also achieved in that the carrier body has an oblique supporting plane, along which the load eye is guided in a shiftable manner between the inoperative position and the functional position, and in which the load eye is deposited in the inoperative position. In the inoperative position, the load eye does not project beyond a surface of the load rail. By means of the oblique supporting plane, a lowering of the load eye into the carrier body and therefore into the load rail is ensured. The oblique supporting plane also permits a low overall height for the load rail in comparison to a load eye lowered vertically into the load rail. Since the carrier body is completely integrated in the load rail and also the load eye, in its inoperative position, is completely recessed in the load rail, i.e. in the carrier body, the possibility is produced for the load rail of being integrated in a loading space floor of the loading space of the motor vehicle in a manner flush with the floor. Accordingly, if the device according to the invention for securing loaded material is not required, a completely flat and flush use possibility is produced over the entire width and length of the loading floor, even in the region of the at least one load rail, for depositing objects for transportation.

The device according to the invention for securing loaded material in a loading space is advantageously usable for use in passenger vehicles, in particular in station wagons, in large capacity limousines and in vans and also in sports utility vehicles (SUVs).

According to the invention, the load eye is configured as a closed ring element and is mounted on the carrier body by means of two guide pins protruding outward on opposite sides from the ring element. This gives rise to a particularly robust load eye which can be produced in a simple manner. Since the load eye is configured as a closed ring element, forces which may occur in the event of a crash, because of tensile strands correspondingly fastened to the load eye, cannot lead to the load eye expanding such that the tensile strand can be released from the load eye.

In a refinement of the invention, the carrier body has a guide track for each guide pin, wherein the guide pins are mounted in the guide tracks both in a linearly movable manner and also in a manner rotatable about a common pivot axis. The guide tracks are preferably configured as grooved or slotted guide tracks which can be configured in a rectilinear or curved manner or as a combination of rectilinear and curved guide portions.

In a further refinement of the invention, the load eye can be secured in its inoperative position on the carrier body or can be released by means of a push-push mechanism. This is a particularly simple and functionally reliable variant for securing or releasing the load eye. The load eye is advantageously spring-loaded in the direction of the functional position, and therefore after being released it inevitably extends into its functional position by means of the push-push mechanism.

In a further refinement of the invention, the carrier body has a pocket-shaped receptacle which is oriented along the oblique supporting plane and in which the guide tracks for the guide pins of the load eye are provided. The pocket-shaped receptacle is coordinated in its dimensions to the external dimensions of the load eye. The guide tracks which are configured as grooves, as slotted guides or as guide contours, are provided on opposite side edges of the pocket-shaped receptacle.

In a further refinement of the invention, the load eye is spring-loaded in the extension direction by means of a spring drive. This advantageous refinement ensures that the load eye after its release is automatically shifted out of the inoperative position in the direction of the functional position.

In a further refinement of the invention, the spring drive has two spring legs acting on the opposite guide pins, said spring legs acting uniformly and simultaneously on the guide pins by means of a synchronization mechanism. As a result, a parallel shifting of the load eye between the inoperative position and the functional position can be achieved in an advantageous manner.

In a further refinement of the invention, the pocket-shaped receptacle and the load eye have mutually complementary undercut contours which secure the load eye in a form-fitting manner in the inoperative position. The load eye is pressed in the inoperative position against the corresponding undercut contour of the pocket-shaped receptacle by the spring drive, as a result of which the load eye is blocked in the inoperative position.

In a further refinement of the invention, the two latching track arrangements are provided in latching strips which are produced separately from the load rail and are inserted into guide grooves of the load rail, said guide grooves being open toward a base of the load rail. The guide grooves of the load rail are preferably open toward at least one end side in order to permit axial pushing of the latching strips into the guide grooves in the longitudinal direction of the load rail.

In a further refinement of the invention, the latching track arrangements are integrally integrated in side limbs of the guide rail, said side limbs flanking the longitudinal groove. The latching track arrangements are preferably formed by latching recesses which are provided in the side limbs.

In a further refinement of the invention, an upper side of the side limbs is covered by at least one cover. The at least one cover covers in particular the latching recesses provided in the side limbs, and therefore, in a fitted state of the load rail in a loading space floor ready for operation, the latching recesses in the side limbs are not visible for the observer. An esthetically attractive uniform image of the load rail and of the loading space floor is produced.

The object on which the invention is based is also achieved in that the load rail has at least one parking depression which is adjacent to a parking position of the load-receiving module and which is coordinated with an outer contour of the load eye in such a manner that the load eye can be deposited in its inoperative position in the parking depression in a manner flush with the load rail. This solution is advantageous in order to be able to move the carrier body of the load-receiving module into a parking position and to deposit the load eye in this parking depression flush with the upper side of the load rail and optionally a loading space floor.

The object on which the invention is based is also achieved in that the load eye is mounted in the carrier body in a vertical longitudinal plane of the carrier body in a pivotable manner between an inoperative position ending flush with an upper side of the load rail and a functional position protruding upward over the upper side of the load rail, and in that the load eye has an integrally molded-on control contour which is formed eccentrically with respect to a pivot axis of the load eye and is configured in such a manner that, during a transfer of the load eye from the inoperative position into the functional position, the control contour is supported on a base of the load rail and presses the carrier body upward. In this solution, the load eye has a dual function since it firstly serves in the functional position for the fastening of a corresponding fastening means, such as a tensile strand or similar, and secondly inevitably moves the carrier body into a latching position during its transfer into the functional position. Additional maneuvers for fixing the carrier body relative to the load rail are not required according to the invention. With the transfer of the load eye into the functional position, the carrier body is inevitably also transferred into its latching position.

In a further refinement of the invention, the carrier body has, in the region of its upper side, latching cams which, in a latching position, engage from below in latching recesses of the load rail, said latching recesses flanking the longitudinal groove of the latching rail on opposite sides. This is a particularly reliable variant for securing the carrier body in the load rail.

In a further refinement of the invention, the carrier body has, in the region of its upper side, at least one feeling element which is mounted movably in the vertical direction, is coordinated with a size of a latching recess, is spring-loaded upward and is spaced apart from at least one latching cam in a manner corresponding to a division of and in alignment with the adjacent latching cams in the longitudinal direction of the carrier body. As soon as the feeling element enters a latching recess, it is ensured that the carrier body is correctly positioned in order, by means of transfer of the load eye from the inoperative position into the functional position, for said load eye to be able to be pressed into its latching position in which the latching cams of the carrier body enter the latching recesses of the load rail.

In a further refinement of the invention, two mutually diametrically opposite latching cams are provided which are molded integrally on a latching lever which is mounted on a carrier body of the load-receiving module so as to be pivotable about a horizontal pivot axis extending transversely with respect to the longitudinal direction of the load-receiving module, and which is assigned a manually operable spring-loaded actuating element, by means of which the latching lever can be transferred into a release position releasing the latching cams from the latching recesses. In this solution, the carrier body is latched in the latching recesses of the load rail via a pivotable latching lever which is spring-loaded in the latching direction.

In a further refinement of the invention, the load-receiving module has a holding receptacle for an adapter part. An adapter part of this type is configured in particular as a pillar of a segmentation module or of a belt webbing module. The adapter part can be inserted in a simple manner into the holding receptacle of the load-receiving module.

In a further refinement of the invention, the adapter part has a manually operable actuating means which, in a state of the adapter part inserted into the holding receptacle, is operatively connected to the latching lever in order, upon manual actuation, to transfer the latching lever into the release position. As a result, when the adapter part is inserted, the load-receiving module can be displaced in a simple manner in the load rail by the actuating means of the adapter part being operated manually. Since the adapter part is placed from above onto the load-receiving module and protrudes upward over the load rail, an ergonomically favorable possibility of adjusting the load-receiving module is thereby provided.

In a further refinement of the invention, the adapter part has a blocking mechanism for releasably securing the adapter part in the holding receptacle, and an operating element is provided on the adapter part, by means of which the blocking mechanism can be transferred into its release position. The blocking mechanism preferably automatically latches when the adapter part is inserted into the holding receptacle of the load-receiving module. By actuation of the operating element, the blocking mechanism can be released, as a result of which the adapter part can be removed again in a simple manner from the holding receptacle of the load-receiving module.

Further advantages and features of the invention emerge from the claims and from the description below of preferred exemplary embodiments of the invention that are illustrated with reference to the drawings.

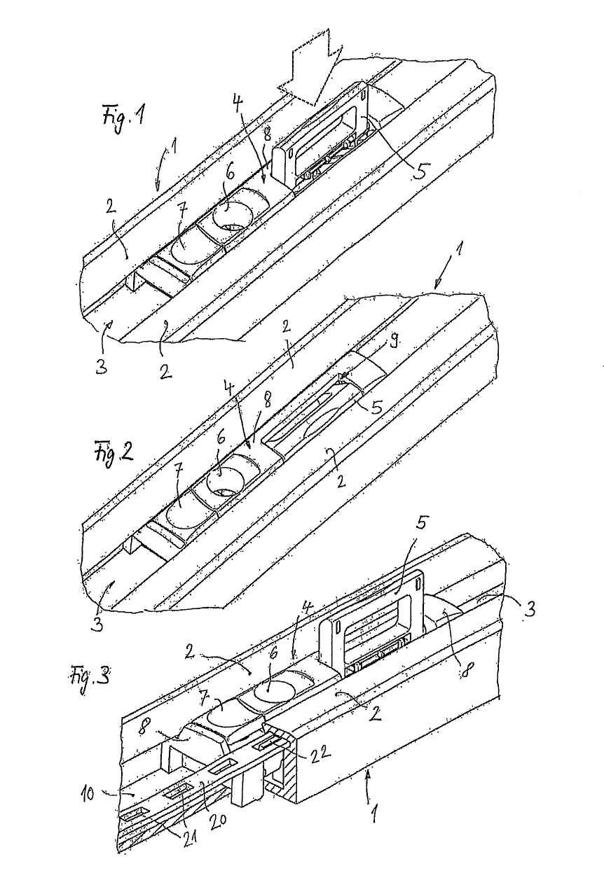

FIG. 1 shows, in a perspective illustration, a detail of an embodiment of a device according to the invention for securing loaded material with a load eye in its functional position,

FIG. 2 shows the device according to FIG. 1 with the load eye in its inoperative position,

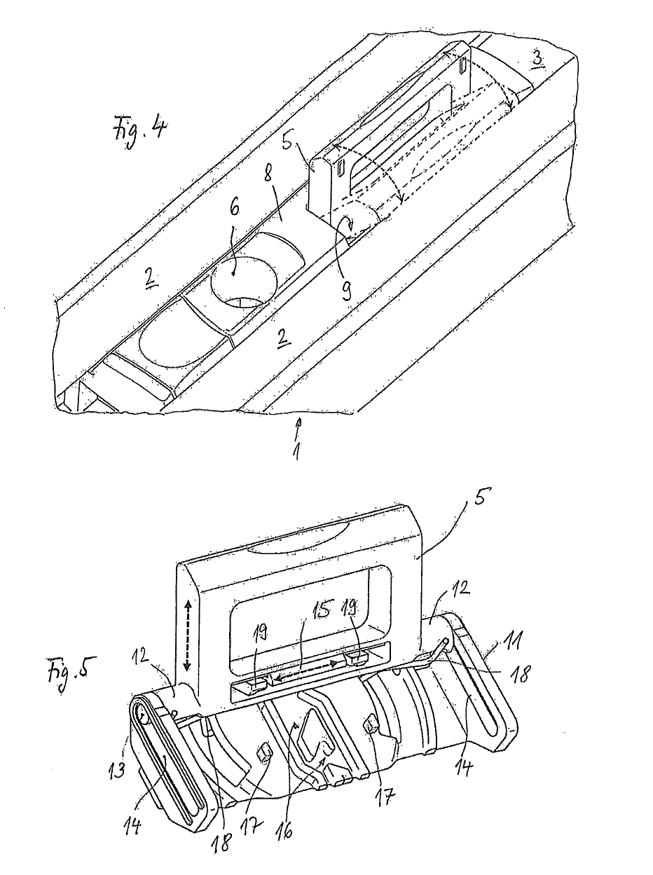

FIG. 3 shows another, partially sectioned, perspective illustration of the device according to FIG. 1,

FIG. 4 shows, in an enlarged perspective illustration, a detail of the device according to FIG. 1,

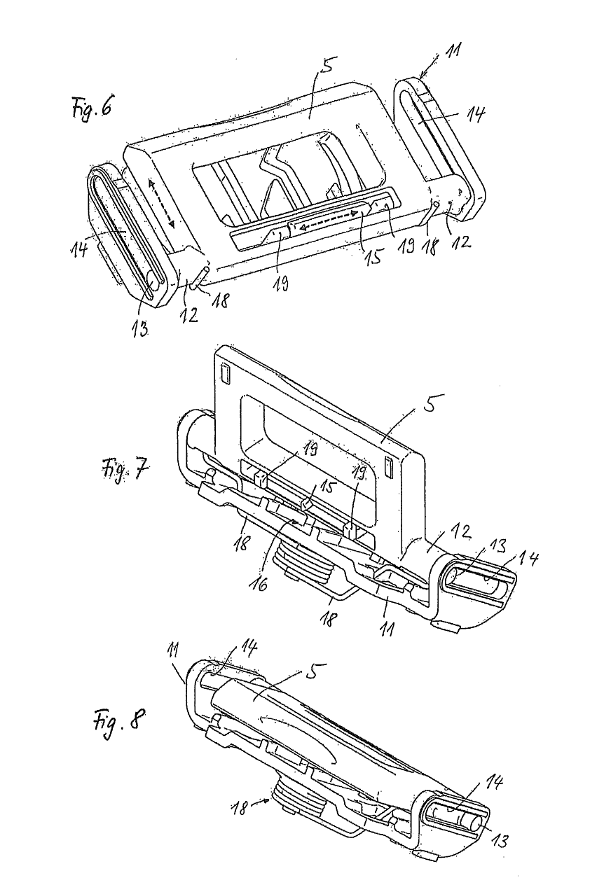

FIG. 5 shows a partial functional region of the device according to FIGS. 1 to 4 in the region of the guiding of the load eye in its functional position,

FIG. 6 shows the illustration according to FIG. 5 in an inoperative position of the load eye,

FIG. 7 shows another perspective illustration of the partial functional region according to FIG. 5,

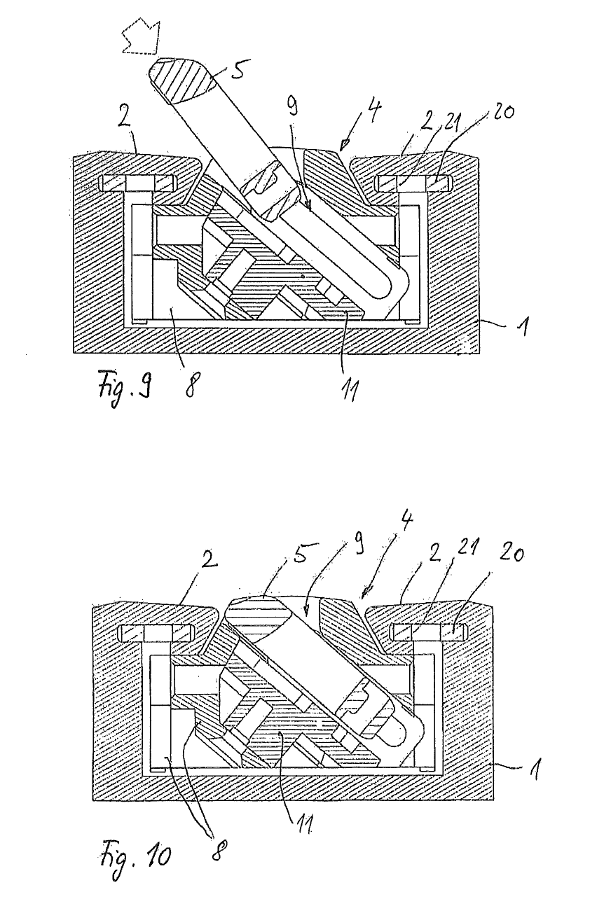

FIG. 8 shows another perspective illustration of the partial functional region according to FIG. 6,

FIG. 9 shows, in a cross-sectional illustration, the device for securing loaded material according to FIGS. 1 to 8,

FIG. 10 shows the cross-sectional illustration according to FIG. 9, but with the load eye in its inoperative position,

FIG. 11 shows, in a cross-sectional illustration, a further embodiment of a device according to the invention for securing loaded material similarly to FIGS. 9 and 10,

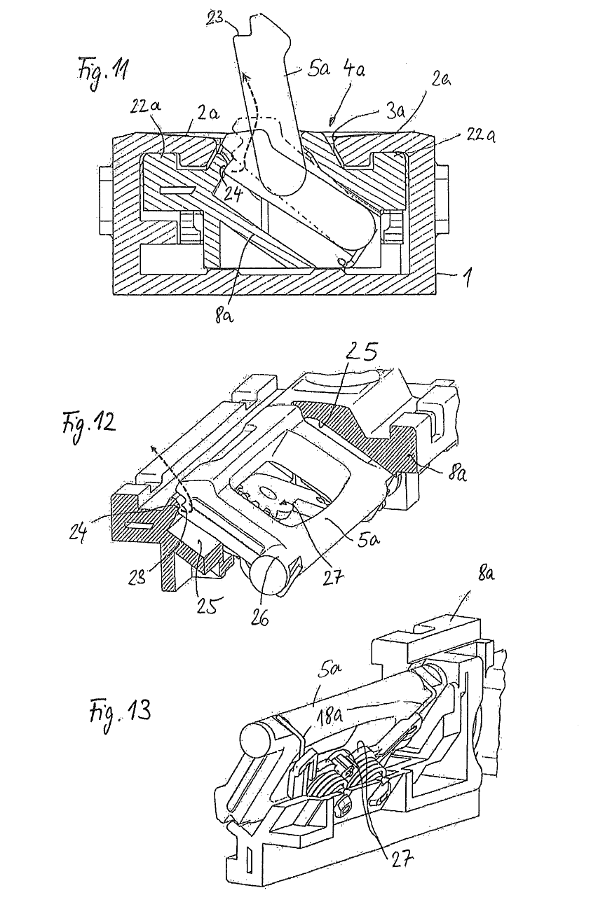

FIG. 12 shows, in a perspective, partially sectioned illustration, a load-receiving module of the device according to FIG. 11,

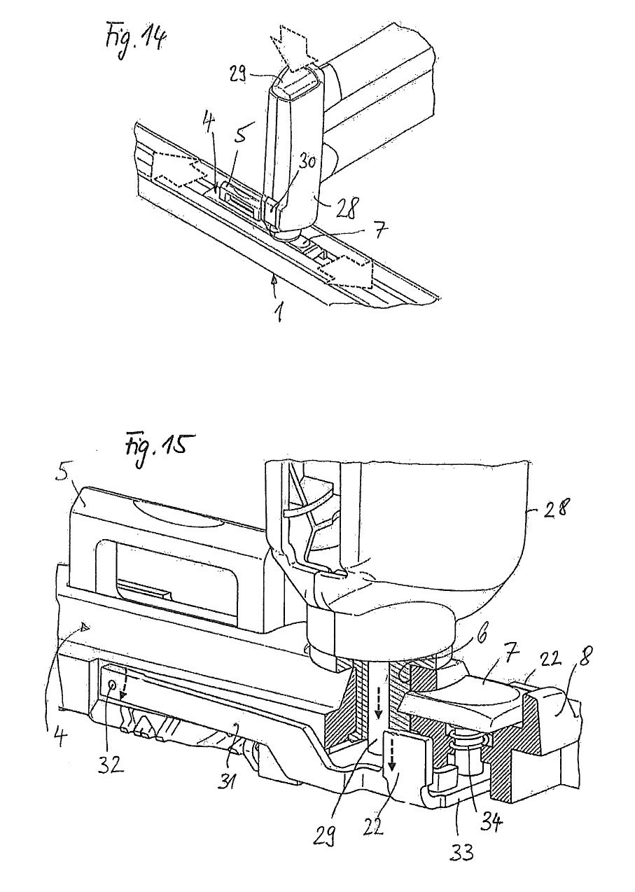

FIG. 13 shows another perspective illustration of the load-receiving module according to FIG. 12,

FIG. 14 shows a further embodiment of a device according to the invention for securing loaded material in a partial perspective illustration,

FIG. 15 shows the embodiment according to FIG. 14 in an enlarged, perspective and partially sectioned illustration,

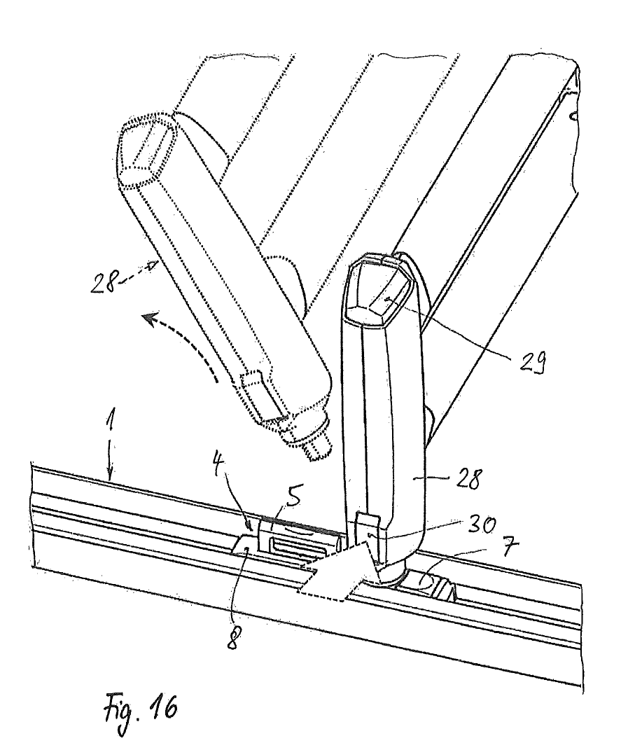

FIG. 16 shows the embodiment according to FIGS. 14 and 15 in a perspective illustration which is enlarged in comparison to the illustration according to FIG. 14,

FIG. 17 shows, in a perspective illustration, a partial region of a load rail of a further embodiment of a device according to the invention for securing loaded material,

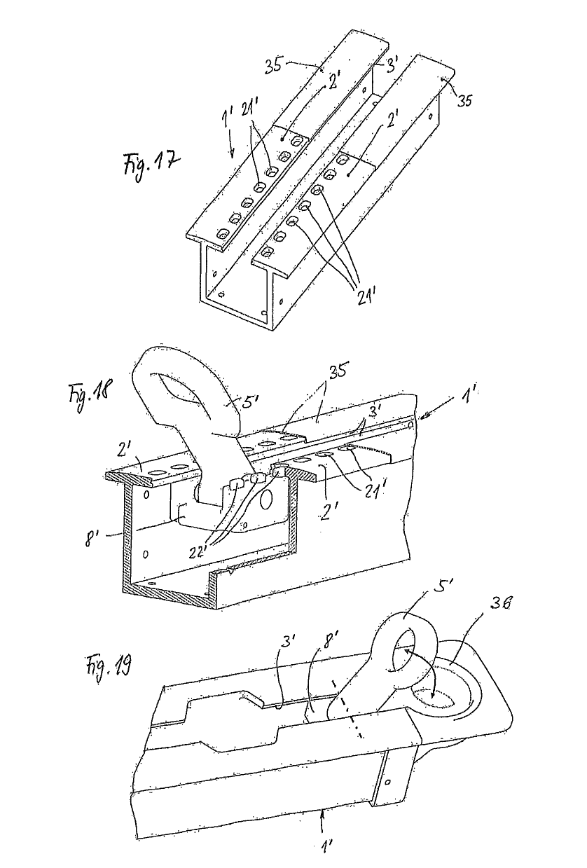

FIG. 18 shows, in a sectioned perspective illustration, the load rail according to FIG. 17 with a load-receiving module which comprises a pivotable load eye,

FIG. 19 shows a further embodiment of a device according to the invention for securing loaded material similarly to FIG. 18,

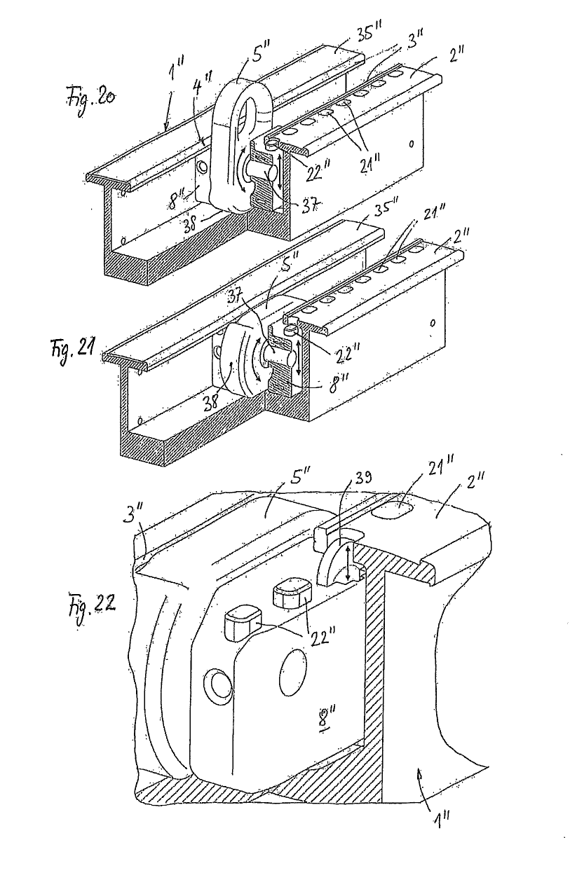

FIGS. 20 and 21 show, in different end positions in the form of a partially sectioned perspective illustration, a further embodiment of a device according to the invention for securing loaded material, and

FIG. 22 shows a partial region of the device according to FIG. 21 in an enlarged, partially sectioned perspective illustration.

A device for securing loaded material in a loading space of a passenger vehicle according to FIGS. 1 to 10 and 14 to 16 has two load rails 1 which are extended in the longitudinal direction of the vehicle on opposite longitudinal sides of the loading space and are embedded in a loading space floor of the loading space in a manner flush with the floor. For clarity reasons, only one of the two load rails 1 is illustrated. The opposite load rail (not illustrated) is configured in an identical manner. The two load rails 1 are anchored fixedly to a body supporting structure of the passenger vehicle, and therefore the load rails 1 remain positioned fixed to the vehicle even in the event of a crash. Only the load rail 1 illustrated with reference to FIGS. 1 to 4, 9, 10 and 14, 16 is discussed below. The description and drawings for this load rail apply in the same manner to the opposite load rail (not illustrated). The same applies to a load-receiving module 4 which is positioned and locked in the load rail 1 in a manner described in more detail below. The statements below apply in the same manner to a load-receiving module which is arranged in the opposite load rail.

The load rail 1 is configured as a metallic hollow profile which, in the region of its upper side (with respect to the operating state of the load rail 1 in which the latter is mounted fixedly on the loading space), is provided with a longitudinal groove 3 extending continuously in the longitudinal direction of the vehicle over an entire length of the load rail 1. The longitudinal groove 3 is flanked on both sides by a respective side limb 2, said side limbs each protruding approximately horizontally from an approximately vertical side wall of the hollow profile of the load rail 1 toward the center. The load rail 1 is also provided with a load rail base 10, and therefore the load rail 1 as a whole defines an approximately C-shaped cross-sectional profile.

Each side limb 2 is in each case assigned a latching track arrangement which is configured as latching strip 20 which is produced over an entire length of the respective side limb 2 (FIGS. 3 and 9, 10). Each latching strip 20 is provided with a row of latching recesses 21 which are arranged distributed at uniform distances in the longitudinal direction of the latching strip 20 and are configured as rectangular passages in the latching strip 20. A length of each latching recess 21—as seen in the longitudinal direction of the load rail 1—is greater than a width of the respective latching recess 21. The respective latching strip 20 is pushed in a form-fitting manner into one guide groove each of the respective side limb 2. For this purpose, the respective guide groove is open toward an end side of the load rail 1, and therefore the respective latching strip 20 can be pushed into the load rail 1 in the longitudinal direction thereof. The respective guide groove runs parallel below an upper side of the respective side limb 2 and is open toward the load rail base 10. As a result, the latching recesses 21 of the latching strip 20 are open from below, i.e. from an interior of the hollow profile of the load rail 1. The downwardly open region of the respective guide groove forms a longitudinal slot. The width of the longitudinal slot corresponds at least to a width of the latching recesses 21 of the latching strip 20.

It can be seen with reference to FIG. 3 and FIGS. 9 and 10 that the latching recesses 21 are closed toward the center of the load rail 1, i.e. toward a center longitudinal axis of the longitudinal groove 3 of the load rail 1. In the region of each latching recess 21, a respective web edge remains on the mutually facing side edges of the opposite latching strips 20, by means of which web edge the latching recesses 21 are closed toward the longitudinal groove 3.

At least one load-receiving module 4 is mounted in a longitudinally displaceable manner in the hollow profile of the load rail 1. The load-receiving module 4 has a longitudinally extending carrier body 8 which is configured as a sliding carriage and is integrated in the hollow profile of the load rail 1. The carrier body 8 has an upwardly open, hollow-cylindrical holding receptacle 6 which serves as a plug-in receptacle for an adapter part 28 (FIGS. 14 to 16). This is discussed further on.

The carrier body 8, in its operating state in which it is inserted into the hollow profile of the load rail 1, does not project beyond an upper side of the side limbs 2 and therefore of the load rail 1. On the contrary, an upper side of the carrier body 8 is at least substantially flush with a surface of the load rail 1.

The load-receiving module 4 has two latching cams 22 which are positioned on opposite longitudinal sides of the carrier body 8 (FIGS. 3 and 15). The opposite latching cams 22 are connected integrally to each other via a connecting web 33 which is part of a latching lever 31. The latching lever 31 is positioned in the region of a lower side of the load-receiving module 4 and is mounted on the carrier body 8 so as to be pivotable about a horizontal pivot axis 32 extending transversely with respect to the longitudinal direction of the load rail 1. The connecting web extends through horizontally below the carrier body 8 transversely over the width thereof. From an upper side of the connecting web 33, a carrier pin projects vertically upward, and an actuating element 7 in the form of a pushbutton is fastened to the upper front end region of said carrier pin. The actuating element 7 and the connecting web 33, and therefore also the latching lever 31, are spring-loaded in the direction of a latching position of the latching cams 22 by means of a helical compression spring 34. Accordingly, a permanent prestress, and accordingly loading upward, is exerted on the two latching cams 22 by the helical compression spring 34 for as long as the actuating element 7 is not manually actuated. The actuating element 7 is mounted in a vertically movable manner in a recess of the carrier body 8 and is accessible from an upper side of the carrier body 8.

It can also be seen with reference to FIG. 15 that a plug-in extension of the adapter part 28 is insertable into the holding receptacle 6. The plug-in extension is provided with a blocking mechanism (not denoted specifically) which engages in a form-fitting manner under a lower edge of the holding receptacle after insertion of the plug-in extension, and therefore the adapter part 28 is locked in a form-fitting manner in its state inserted into the holding receptacle 6. The blocking mechanism can be transferred by the operating element 30 into its release position in which the adapter part 28 can be removed again upward, according to the illustration according to FIG. 16.

In the embodiment according to FIGS. 14 to 16, the adapter part 28 is configured as a column element which is oriented in the vertical direction of the vehicle and is part of a segmentation module of the device for securing loaded material in the loading space. The adapter part 28 is passed through in the vertical direction by an actuating rod 29 which constitutes an actuating means within the context of the invention. An actuating button is fastened on an upper front end region of the actuating rod 29. As can be seen with reference to FIG. 15, the actuating rod 29 projects downward through the plug-in extension of the adapter part 28 and can be pressed downward over a lower front edge of the plug-in extension in accordance with the dashed-line arrow. The lower end side of the actuating rod 29 comes into contact with a surface of the connecting web 23. As soon as a pressure is exerted downward on the actuating button of the actuating rod 29 from above (see dashed-line arrow in FIG. 14), the lower end of the actuating rod 29 presses the connecting web 33 downward, as a result of which, in accordance with the dashed-line arrow in FIG. 15, the latching cams 22 are pressed downward out of the latching recesses 21 of the opposite latching strips 20. The load-receiving module 4 can thereby be displaced in the longitudinal direction of the load rail 1. As soon as the compressive force on the actuating button of the actuating rod 29 is removed again, the helical compression spring 34 presses the latching cams 22 upward again, as a result of which the latching cams 22 can latch into a further pair of opposite latching recesses 21.

In addition, the carrier body 8 bears a load eye 5 which is held in the carrier body 8. The load eye 5 is designed as a single-part, closed ring element, wherein a ring shape is defined by a substantially rectangular closed frame shape. The load eye 5 which—as also the carrier body 8—is produced from metal has, on its lower region, two guide pins 12 which protrude laterally outward from side flanks of the load eye 5 on opposite sides and are molded integrally on the load eye 5. The guide pins 12 each have a cylindrical sliding block 13 which is mounted in a linearly displaceable manner in one guide track each in the form of a guide slot 14. The two guide slots 14 on opposite sides of the load eye 5 extend in a common plane which constitutes an oblique plane relative to a sliding plane of the carrier body 8. The two guide slots 14 are arranged in a partial functional region 11 of the carrier body 8 that is insertable together with the load eye 5 as a preassembled constructional unit into the carrier body 8 and is fixedly connectable to the latter. The oblique plane forms a supporting plane for guiding and securing the load eye 5 in the carrier body 8. For this purpose, the carrier body 8 forms a pocket-shaped receptacle 9. In the inserted state of the load-receiving module 4 in the load rail 1, the oblique supporting plane, in which or parallel to which the guide slots 14 also extend, is inclined toward the side with respect to a vertical center longitudinal plane of the load rail 1. This can readily be seen with reference to FIG. 4. This is because the load eye 5 is held in the pocket-shaped receptacle 9 on the partial functional region 11 of the carrier body 8 so as to be shiftable between an upwardly erected functional position projecting upward over an upper side of the side limbs 2 and an inoperative position (illustrated by chain-dotted lines). For this purpose, the load eye 5 firstly carries out a displacement movement along the oblique supporting plane in order to be able to move obliquely out of the pocket-shaped receptacle 9. Subsequently, the load eye 5 is oriented vertically in a spring-loaded manner into the functional position, and therefore pivoting along the dashed-lined arrows in FIG. 4 takes place. Accordingly, the sliding blocks 13 of the guide pins 12 are mounted in the guide slots 14 in a longitudinally displaceable and also rotatable manner.

The load eye 5 is assigned a spring drive 18 which is formed by a leg spring acting with its opposite leg ends on the two guide pins 12 of the load eye 5. It can be seen with reference to FIG. 10 that the pocket-shaped receptacle 9 defines a movement clearance for the load eye 5, which movement clearance initially only permits a longitudinal shifting upward along the oblique supporting plane from a recessed inoperative position (FIG. 10). As soon as the sliding blocks 13 of the guide pins 12 have reached an upper end region of the guide slots 14, the leg ends of the spring drive 18 press the load eye 5 into its upright pivoted position. For this purpose, the guide pins 12 are provided with an eccentric contour (not denoted specifically), the eccentric contour being configured as flattened portions and against which the leg ends of the spring drive 18 lie in linear contact. As a result, support of the load eye 5 in the upright functional position is brought about via the leg ends of the spring drive 18. An impulse in order to transfer the load eye 5 from the linear sliding movement into a pivoting movement can be configured by an edge region of the longitudinal groove 3 in the region of a side limb 2 along which a corresponding contact surface of the load eye 5 slides. This can be seen with reference to FIGS. 9 and 10.

In order to secure the load eye 5 in its recessed inoperative position according to FIGS. 6, 8 and 10, a push-push mechanism 15, 16, 17, 19 which can be seen with reference to FIGS. 5 to 8 is provided. The push-push mechanism has a forced guidance for a guide cam 15 along a cardioid track 16 which is configured in the manner of the ballpoint pen principle. The guide cam 15 is also assigned two lateral supporting cams 19 which, together with the guide cam 15, are mounted in the load eye 5 so as to be displaceable parallel to the pivot axis of the sliding blocks 13 of the guide pins 12 of the load eye 5. Two stops 17 which further improve support of the load eye 5 as an addition to the guide cam 15 are assigned to the supporting cams 19 in a stationary manner on the side of the oblique supporting plane. The leg spring forming the spring drive 18 is mounted below the oblique supporting plane of the partial functional region 11 and projects with the two leg ends through corresponding passages to the front side of the oblique supporting plane on which the load eye 5 is shiftable.

The load eye 5 can therefore be guided out of the latching position of the cardioid track 16 and the stops 17 by simple manual pressure obliquely from above, as a result of which the spring drive 18 inevitably transfers the load eye 5 into its upright functional position according to FIGS. 5 and 7. Pushing in again likewise takes place manually by means of pressure from above, as a result of which the load eye 5 is pushed back again into the pocket-shaped receptacle 9 counter to the spring force of the spring drive 18.

A slightly modified exemplary embodiment is provided with reference to FIGS. 11 to 13. Functionally identical or identical parts and portions of the device according to FIGS. 11 to 13 are provided with the same reference signs with the addition of the letter a. A substantial difference is that, in order to secure the load eye 5a in the recessed inoperative position, a push-push mechanism according to the previously described exemplary embodiment is not provided, but rather the load eye 5a is blocked in the recessed inoperative position by means of undercut contours 23, 24 in the region of the pocket-shaped receptacle and in the region of a front edge of the load eye 5a. The load eye 5a is also assigned a spring drive 18a in order to move the load eye 5a from the recessed inoperative position in the direction of the upright functional position. The spring drive 18a likewise has two leg ends which interact with flattened regions of the guide pins 26 of the load eye 5a. However, in the embodiment according to FIGS. 11 to 13, the spring drive 18a is not formed by an individual leg spring, but rather by two leg springs which act uniformly and simultaneously on the guide pins 26 via a synchronization mechanism 27. The guide pins 26 are assigned groove-shaped guide slots 25 which extend along the oblique supporting plane. The pocket-shaped receptacle has undercut contours 24 which are assigned a complementary undercut contour 23 on the load eye 5a. It can be seen with reference to FIG. 11 that the compressive force of the spring drive 18a first of all presses the load eye 5a upward along the oblique supporting plane in such a manner that the undercut contour 23 of the load eye 5a lies against the undercut contour 24 of the carrier body and therefore of the pocket-shaped receptacle and is supported on the latter. Only if a manual loading from above is exerted on the load eye 5a in this recessed inoperative position according to FIG. 11 does the load eye 5a come free from the undercut contour 24, as a result of which the spring drive 18a brings about the inevitable deployment into the upright functional position. The synchronization mechanism 27 is formed by two intermeshing toothing limbs which guide the leg ends of the two leg springs (FIGS. 12 and 13). The toothing levers are mounted on the oblique supporting plane so as to be pivotable about mutually parallel pivot axes which are oriented coaxially with respect to the fastening axes of the two leg springs. Accordingly, the pivot axes are orthogonal to the oblique supporting plane.

A load rail 1′ of a device for securing loaded material in a loading space of a passenger vehicle is shown with reference to FIGS. 17 and 18. The load rail 1′ is likewise configured as a hollow profile which, in the region of its upper side, has two side limbs 2′ which flank a longitudinal groove 3′ running centrally in the longitudinal direction. Also in the case of the load rail 1′, each side limb 2′ is provided with a latching track arrangement which is formed by a row of latching recesses 21′ arranged distributed at uniform distances from one another in the longitudinal direction of the load rail 1′. Like the previously described latching recesses 21, the latching recesses 21′ are also closed toward the longitudinal groove 3′. A substantial difference over the previously described load rail 1 is that the latching recesses 21′ are formed integrally in the side limbs 2′. In this case, the latching recesses 21′ form passages in the respective side limbs 2′, which passages are open upward and downward, whereas they are closed peripherally with respect to the sides. In order to conceal the perforation pattern of the side limbs 2′ correspondingly formed by the latching recesses 21′, each side limb 2′ is provided with a cover 35 which is illustrated in sectioned form with reference to FIGS. 17 and 18. It can be seen with reference to FIGS. 17 and 18 that the covers 35 are provided as thin-walled, open hollow profiles with an approximately C-shaped profile cross section, the covers being pushed in a simple manner in the longitudinal direction onto the side limbs 2′ from an end side. Corresponding opposite side edge regions of each cover 35 engage behind corresponding edge profilings of the respective side limb 2′ in order to obtain the form-fitting retention effective in the vertical direction and in the transverse direction of the load rail 1′. A load-receiving module which comprises a carrier body 8′ and a load eye 5′ is shown with reference to FIG. 18. The carrier body 8′ is integrated in the hollow profile of the load rail 1′ and has, in the region of its upper side, a plurality of latching cams 22′ in each case on both sides of the load eye 5′, said latching cams being adapted in their design and arrangement to the row of latching recesses 21′ of the side limbs 2′. The carrier body 8′ is mounted displaceably on a load rail base of the load rail 1′ by means of a guide unit (not illustrated). The carrier body 8′ can be arranged so as to be movable in a spring-loaded manner to a limited extent in the vertical direction in order to enable the latching cams 22′ to latch upward and to be pressed downward relative to the latching recesses 21′. The load eye 5′ is mounted in the carrier body 8′ so as to be pivotable about a horizontal pivot axis extending transversely with respect to the longitudinal direction of the load rail 1′ and has an annular receiving region which projects upward over a surface of the load rail 1′. In order to be able to deposit the load eye 5′ flush with a surface of the load rail 1′ in a parking position, a parking depression 36 is provided on an end region of the load rail 1′, according to FIG. 19, said parking depression being integrated in a component attached to the load rail 1′ on the end side. The illustration of the load eye 5′ is merely schematic and differs from the illustration of the load eye 5′ according to FIG. 18. However, the load eyes 5′ in FIGS. 18 and 19 are identical in terms of their function. If the load eye 5′ according to FIG. 19 is configured in its contours in accordance with the illustration according to FIG. 18, the parking depression 36 is also correspondingly coordinated with said outer contours of the load eye 5′.

In the embodiment according to FIGS. 20 to 22, a load rail 1″ is substantially constructed in the same manner as the load rail 1′ according to FIGS. 17 and 18. A substantial difference in the case of the load rail 1″ is that the upper-side covers 35″ do not engage around the side limbs 2″ on the outer side, but rather are pushed into corresponding longitudinal profilings in the region of the upper side of the side limbs 2′. This can readily be seen with reference to FIGS. 20 and 21. Also in the case of the embodiment according to FIGS. 20 to 22, the side limbs 2′ are provided with one latching track arrangement each consisting of a row of latching recesses 21″ which are configured identically to the latching recesses 21′ according to FIGS. 17 and 18. A load-receiving module 4″ which comprises a carrier body 8″ and a load eye 5″ is accommodated in the load rail 1″. The carrier body 8″ is configured in the manner of a block in order to be displaceable in a sliding manner in the hollow profile of the load rail 1″. The carrier body 8″ does not project beyond an upper side of the longitudinal groove 3″. The carrier body 8″ is provided with a central passage (not denoted specifically) which is oriented in a vertical central longitudinal plane. A load eye 5 which is mounted in said vertical central longitudinal plane in the carrier body 8″ so as to be pivotable about a pivot axis 37 is arranged in the passage. The load eye 5″ has a closed ring element which, in an upright functional position according to FIG. 20, projects upward over the upper side of the load rail 1″. The load eye 5″ is configured as a single-part body which has the ring element. In addition, the load eye 5″ is provided with an eccentric control contour 38 which has a greater distance from the pivot axis 37 than opposite side flanks of the load eye 5″. A distance between the opposite side flanks of the load eye 5″ approximately corresponds to a height of the cavity, which is defined by the hollow profile of the load rail 1″, between the load rail base and the longitudinal groove 3″. In a recessed inoperative position, the one side flank of the load eye 5″ rests flat on the load rail base while the other side flank (FIG. 21) ends substantially flush with the longitudinal groove 3″ and the upper side of the side limbs 2″. As soon as the load eye 5″ is then pivoted upward manually out of said recessed inoperative position, the excentric control contour 38 comes into contact with the load rail base and inevitably presses the carrier body 8″ upward in the vertical direction (see arrow illustrations in FIG. 21). The carrier body 8″ in each case has at least one row of at least two latching cams 22″ on both sides of the load eye 5″, said latching cams being coordinated in their dimensions and arrangement to the latching recesses 21″. Owing to the fact that the carrier body 8″ is pressed upward after the load eye 5″ has pivoted upward, the latching cams 22″ enter the corresponding latching recesses 21″ on the opposite sides of the longitudinal groove 3″.

In order to ensure that, when the load eye 5″ has pivoted upward, the carrier body 8″ is located with its latching cams 22″ exactly below complementary latching recesses 21″, at least one feeling element 39 is provided in the region of the upper side of the carrier body 8″, said feeling element being designed as a small feeler wheel which is spring-loaded in the vertical direction, in the embodiment according to FIG. 22. The feeling element 39 is coordinated in its positioning to the division of the latching recesses 21″ and the latching cams 22″. As soon as the carrier body 8″ is accordingly displaced in the longitudinal direction of the load rail 1″ to such an extent that the feeling element 39 enters into a latching recess 21″ from below, it is ensured that the adjacent latching cams 22″ are located exactly below correspondingly adjacent latching recesses 21″, and therefore the load eye 5″ can be pivoted upward. By this means, the latching cams 22″ inevitably enter the corresponding latching recesses 21″ from below. In the embodiment according to FIGS. 20 to 22, two feeling elements 39 are provided on the opposite upper sides of the carrier body 8″, the upper sides flanking the load eye 5″. As soon as the feeling elements 39 have latched in the corresponding latching recesses 21″, a certain form-fitting securing of the carrier body 8″ in the longitudinal direction of the load rail 1″ and therefore in the displacement direction of the carrier body 8″ is also achieved, and therefore pivoting of the load eye 5″ upward also cannot lead to the carrier body 8″ being slightly shifted again in the longitudinal direction, as a result of which the latching cams 22″ would no longer be positioned exactly below the latching recesses 21″.

1. A device for securing loaded material in a loading space of a motor vehicle, with at least one load rail which can be anchored fixedly to the vehicle and is configured as a hollow profile, which is provided with a longitudinal groove which is open toward the loading space and is flanked by at least one latching track arrangement, which is provided at least with a row of latching recesses arranged one behind another in the longitudinal direction of the load rail, and with at least one load-receiving module which is arranged in the load rail in a displaceable and lockable manner, wherein the load-receiving module has at least one latching cam which, in a latching position of the load-receiving module, engages in a latching recess of the latching track arrangement, wherein two latching track arrangements are arranged on opposite sides of the longitudinal groove, and in that the latching recesses thereof are each closed toward the longitudinal groove.

2. A device for securing loaded material in a loading space of a motor vehicle, with at least one load rail which can be anchored fixedly to the vehicle on a loading space floor and is configured as a hollow profile with a longitudinal groove which is open toward the loading space, and with at least one load-receiving module which has a carrier body, which is displaceable and lockable in the load rail, and a load eye which is mounted movably on the carrier body between an inoperative position lowered into the load rail and a functional position protruding upward over the load rail, wherein the carrier body has an oblique supporting plane, along which the load eye is guided in a shiftable manner between the inoperative position and the functional position, and in which the load eye is deposited in the inoperative position.

3. The device as claimed in claim 2, wherein the load eye is configured as a closed ring element and is mounted on the carrier body by means of two guide pins protruding outward on opposite sides from the ring element.

4. The device as claimed in claim 3, wherein the carrier body has a guide track for each guide pin, wherein the guide pins are mounted in the guide tracks both in a linearly movable manner and also in a manner rotatable about a common pivot axis.

5. The device as claimed in claim 2, wherein the load eye can be secured in its inoperative position on the carrier body or can be released by means of a push-push mechanism.

6. The device as claimed in claim 2, wherein the carrier body has a pocket-shaped receptacle which is oriented along the oblique supporting plane and in which the guide tracks for the guide pins of the load eye are provided.

7. The device as claimed in claim 2, wherein the load eye is spring-loaded in the extension direction by means of a spring drive.

8. The device as claimed in claim 7, wherein the spring drive has two spring legs acting on the opposite guide pins, said spring legs acting uniformly and simultaneously on the guide pins by means of a synchronization mechanism.

9. The device as claimed in claim 2, wherein a pocket-shaped receptacle and the load eye have mutually complementary undercut contours which secure the load eye in a form-fitting manner in the inoperative position.

10. The device as claimed in claim 1, wherein the two latching track arrangements are provided in latching strips which are produced separately from the load rail and are inserted into guide grooves of the load rail, said guide grooves being open toward a base of the load rail.

11. The device as claimed in claim 1, wherein the latching track arrangements are integrally integrated in side limbs of the guide rail, said side limbs flanking the longitudinal groove.

12. The device as claimed in claim 11, wherein an upper side of the side limbs is covered by at least one cover.

13. The device as claimed in claim 2, wherein the load rail has at least one parking depression which is adjacent to a parking position of the load-receiving module and which is coordinated with an outer contour of the load eye in such a manner that the load eye can be deposited in its inoperative position in the parking depression in a manner flush with the load rail.

14. The device as claimed in claim 2, wherein the load eye is mounted in the carrier body in a vertical longitudinal plane of the carrier body in a pivotable manner between an inoperative position ending flush with an upper side of the load rail and a functional position protruding upward over the upper side of the load rail, and in that the load eye has an integrally molded-on control contour which is formed eccentrically with respect to a pivot axis of the load eye and is configured in such a manner that, during a transfer of the load eye from the inoperative position into the functional position, the control contour is supported on a base of the load rail and presses the carrier body upward.

15. The device as claimed in claim 14, wherein the carrier body has, in the region of its upper side, latching cams which, in a latching position, engage from below in latching recesses of the load rail, said latching recesses flanking the longitudinal groove of the latching rail on opposite sides.

16. The device as claimed in claim 14, wherein the carrier body has, in the region of its upper side, at least one feeling element which is mounted movably in the vertical direction, is coordinated with a size of a latching recess, is spring-loaded upward and is spaced apart from at least one latching cam in a manner corresponding to a division of and in alignment with the adjacent latching cams in the longitudinal direction of the carrier body.

17. The device as claimed in claim 1, wherein two mutually diametrically opposite latching cams are provided which are molded integrally on a latching lever which is mounted on a carrier body of the load-receiving module so as to be pivotable about a horizontal pivot axis extending transversely with respect to the longitudinal direction of the load-receiving module, and which is assigned a manually operable spring-loaded actuating element, by means of which the latching lever can be transferred into a release position releasing the latching cams from the latching recesses.

18. The device as claimed in claim 1, wherein the load-receiving module has a holding receptacle for an adapter part.

19. The device as claimed in claim 18, wherein the adapter part has a manually operable actuating means which, in a state of the adapter part inserted into the holding receptacle, is operatively connected to the latching lever in order, upon manual actuation, to transfer the latching lever into the release position.

20. The device as claimed in claim 18, wherein the adapter part has a blocking mechanism for releasably securing the adapter part in the holding receptacle, and in that an operating element is provided on the adapter part, by means of which the blocking mechanism can be transferred into its release position.

21. A device for securing loaded material in a loading space of a motor vehicle, with at least one load rail which can be anchored fixedly to the vehicle on a loading space floor and is configured as a hollow profile with a longitudinal groove which is open toward the loading space, and with at least one load-receiving module which has a carrier body, which is displaceable and lockable in the load rail, and a load eye which is mounted movably on the carrier body between an inoperative position lowered into the load rail and a functional position protruding upward over the load rail, wherein the load eye is configured as a closed ring element and is mounted on the carrier body by two guide pins protruding outward on opposite sides from the ring element.

22. A device for securing loaded material in a loading space of a motor vehicle, with at least one load rail which can be anchored fixedly to the vehicle on a loading space floor and is configured as a hollow profile with a longitudinal groove which is open toward the loading space, and with at least one load-receiving module which has a carrier body, which is displaceable and lockable in the load rail, and a load eye which is mounted movably on the carrier body between an inoperative position lowered into the load rail and a functional position protruding upward over the load rail, wherein the load rail has at least one parking depression which is adjacent to a parking position of the load-receiving module and which is coordinated with an outer contour of the load eye in such a manner that the load eye can be deposited in its inoperative position in the parking depression in a manner flush with the load rail.

23. A device for securing loaded material in a loading space of a motor vehicle, with at least one load rail which can be anchored fixedly to the vehicle on a loading space floor and is configured as a hollow profile with a longitudinal groove which is open toward the loading space, and with at least one load-receiving module which has a carrier body, which is displaceable and lockable in the load rail, and a load eye which is mounted movably on the carrier body between an inoperative position lowered into the load rail and a functional position protruding upward over the load rail, wherein the load eye is mounted in the carrier body in a vertical longitudinal plane of the carrier body in a pivotable manner between an inoperative position ending flush with an upper side of the load rail and a functional position protruding upward over the upper side of the load rail, and the load eye has an integrally molded-on control contour which is formed eccentrically with respect to a pivot axis of the load eye and is configured in such a manner that, during a transfer of the load eye from the inoperative position into the functional position, the control contour is supported on a base of the load rail and presses the carrier body upward.
